(19) United States
(12) Patent Application Publication
(10) Pub. No.: US 2011/0095906 A1
(43) Pub. Date: Apr. 28, 2011

(54) METHOD AND DEVICE FOR CONTROLLING TRAFFIC FLOW

(75) Inventor: Ulrich Stählin, Eschborn (DE)

(73) Assignee: Continental Teves AG & Co. oHG, Frankfurt (DE)

(21) Appl. No.: 12/675,003

(22) PCT Filed: Aug. 1, 2008
(86) PCT No.: PCT/EP08/60126

§ 371 Date: Jan. 14, 2011

(30) Foreign Application Priority Data
Aug. 29, 2007 (DE) 10 2007 040 985.2

(51) Int. Cl. G08G 1/09

(52) U.S. Cl. 340/905

(57) ABSTRACT

A method and an apparatus for controlling the flow of traffic. To this end, the information about the period of time before a set of traffic lights changes to another traffic light phase is used to provide the driver of a vehicle with a speed recommendation for approaching the traffic lights. In order to improve the ascertainment of the speed recommendation, provision is made for a database to be used to store the position (P) and the change times (Si) of a set of traffic lights and for the position and change times to be able to be retrieved by a vehicle via a mobile radio communication link, and for the driver of the vehicle to be provided with the speed recommendation using this information.

### CROSS REFERENCE TO RELATED APPLICATIONS

This application is the U.S. national phase application of PCT International Application No. PCT/EP2008/060126, filed Aug. 1, 2008, which claims priority to German Patent Application No. 10 2007 040 985.2, filed Aug. 29, 2007, the contents of such applications being incorporated by reference herein.

### FIELD OF THE INVENTION

The invention relates to a method and an apparatus for controlling the flow of traffic. In this context, provision is made for the information about the period of time before a set of traffic lights changes to another traffic light phase, i.e. particularly red, amber or green, to be used to provide the driver of a vehicle with a speed recommendation for approaching the traffic lights. A set of traffic lights within the context of the invention is any traffic light installation which gives instructions to vehicles in road traffic.

### BACKGROUND OF THE INVENTION

With such traffic light phase assistants, the information about the period before the traffic lights change to the next traffic light phase, for example from green to amber to red, is thus used to indicate to the driver the speed at which he has a green wave, i.e. whether he can still go through the traffic lights on green or whether they will change to red beforehand and force him to stop. To provide this function of the traffic light phase assistant, it is necessary for the vehicle to know the change times between the individual phases of the traffic lights. Typically, this is done using direct communication between the traffic lights and the vehicle, said communication being used to communicate the change times. This involves the use of what is known as Dedicated Short Range Communication (DSRC) in particular, i.e. vehicle-to-infrastructure communication on the basis of ad-hoc networks.

However, this entails the problem that said ad-hoc networks are frequently not set up quickly enough or are not available to all vehicles on the basis of the hardware in the individual vehicles. In addition, the range of the communication is insufficient to predictively provide speed recommendations for a large number of traffic lights passed in succession which are based on said traffic lights as a whole.

### SUMMARY OF THE INVENTION

It is therefore an object of the present invention to achieve an improvement in the ascertainment of the speed recommendation, with more vehicles being able to be reached overall.

In the case of the method proposed in accordance with the invention, a database having the function of a server is used to store the position and the change times of a set of traffic lights for a large number of traffic lights. A mobile radio communication link can be used by a motor vehicle to retrieve said data (position and change times), so that the driver of a vehicle is provided with the speed recommendation using this information, i.e. particularly change times and/or position of the traffic lights. By using a preferably central database to store the change times for the traffic light phases, it is thus possible to use the change times of these traffic lights for calculating speed recommendations for a traffic light phase assistant even without a direct radio link to these specific traffic lights. Since many of the vehicles already have mobile radio communication or will have it in future, for example in order to implement an Ecall (automatic emergency call), wherein the mobile radio communication devices are connected to a driver assistance system, for example, a large number of vehicles can be reached in this manner without the need for the use of new hardware. In addition, the central management of the change times for the traffic lights affords an advantage for traffic planning, since it is also possible to resort to these data for developing traffic concepts, and they can be used in simulations.

In line with the invention, provision is made, in particular, for the position of the vehicle relative to the traffic lights also to be taken into account for the speed recommendation to the driver, particularly in order to establish whether what is known as a green wave can be produced for the driver, i.e. the driver is not forced to stop upon reaching the traffic lights, within the permitted maximum speed, which can be transmitted as a further parameter with the position and change times of the traffic lights, for example.

In line with a further development of this method variant, the position of the vehicle and the position of the traffic lights can be taken into account in a digital roadmap, said digital roadmap also recording the admissible maximum speeds, for example. In this case, this speed would not need to be transmitted in the data transmission at the same time. Furthermore, this method variant allows a prediction of whether a set of traffic lights is on the route of the vehicle, and allows the change times to be retrieved for these traffic lights by the vehicle in advance.

In line with the invention, the database is for this purpose preferably sorted such that the data are retrieved using the position data for the traffic lights and/or for the vehicle, i.e. the traffic lights are sorted in the database according to preferably global coordinates for a position or navigation system, for example in order to take transmitted vehicle positions as a basis for transmitting the change times of the upcoming traffic lights and also possibly the subsequent traffic lights.

A further improvement in the prediction accuracy can be achieved if navigation data for the vehicle are taken into account for the speed recommendation. This can be done in the case of a journey which is input into a navigation system particularly by virtue of further traffic lights on the road being taken into account for ascertaining the speed recommendation, and a green wave being achieved for a plurality of successive traffic lights even when departing from a main traffic route. For main traffic routes, the traffic light phases are frequently pre-configured such that a green wave is set. If no journey route has been input, the navigation data for the vehicle can also be interpreted to stipulate a more probable path along a journey route and to output a speed recommendation for this. If the ascertainment of the speed recommendation involves not only the next traffic lights but also the subsequent traffic lights on a longer drive being taken into account, it may make sense, in line with the invention, to take account of the upcoming and possibly the next traffic lights using a higher weighting. The effect achieved by this is that an optimized speed recommendation is given for the immediately following traffic lights, since, particularly in cities, it is not possible to predict whether obstacles will arise on the onward road which force a departure from the speed recommendation anyway.

In a further development of the method proposed in line with the invention, provision may also be made for the current or a currently averaged speed of the vehicle to be taken into account for the speed recommendation, for example using a speed corridor situated around this current or currently averaged speed. This allows a comfortable speed for the driver or a traffic situation to be taken into account straight away for ascertaining the speed recommendation.

To avoid inaccuracies as a result of time tolerances of realtime clocks, one particularly preferred embodiment of the invention proposes that the reference time used be the time base of a preferably global positioning or navigation system. A positioning or navigation system of this kind may, in particular, be the GPS system or the future European satellite position-finding system Galileo or comparable systems which perform position finding on the basis of satellite signals using an accurate time base.

To keep the database proposed in accordance with the invention up to date, it is also possible for the database to be updated dynamically, particularly in the case of dynamic adaptation of the traffic light phases, i.e. the period of time before the traffic light phase changes. This can preferably be implemented using a mobile radio link, or particularly also in cities, wired communication networks such as bus systems. In line with the invention, these communication options between the traffic lights and the database can also be used in parallel for maintenance tasks or for the transmission of fault reports.

In line with one advantageous implementation, it is proposed that the mobile radio communication link be implemented using 2 G, 2.5 G, 2.75 G, 3 G and/or 4 G mobile radio networks, which provide sufficient data transmission capacities for the data which are to be transmitted. However, the invention is not limited to the known mobile radio communication solutions, but rather can, in principle, also be implemented with other radio communication solutions which allow secure data transmission from a central server with a database to mobile vehicles and/or traffic lights.

To reduce the number of radio transmissions, one particularly advantageous variant of the method may have provision for the transmission of the change times for the upcoming traffic lights to also involve simultaneous transmission of the change times for one or more subsequent set(s) of traffic lights, particularly in each case together with the position data. This means that the vehicle has all the information available and this information can be taken into account by the traffic light phase assistant without further radio communication when the speed recommendation is ascertained.

The invention also relates to an apparatus for controlling the flow of traffic for use with a traffic light phase assistant. The traffic light phase assistant used for the apparatus is set up to take information about the period of time before a set of traffic lights changes to another traffic light phase as a basis for providing the driver of a vehicle with a speed recommendation for approaching the traffic lights. In this case, the apparatus according to aspects of the invention may both be designed for connection to a traffic light phase assistant and also contain an integrated traffic light phase assistant.

In line with the invention, the apparatus, particularly a data server, contains a database which stores the position and the change times for a set of traffic lights for a multiplicity of traffic lights. Change times are the changeover times between the traffic light phases (for example red, amber, green), and it is also sufficient, for performing the method according to aspects of the invention, to take account of just the change times for the phases red and green, since the amber phases are very short and do not necessarily have to be taken into account for a speed recommendation. In line with the invention, the database has a mobile radio communication device connected to it which allows the position and the change times of one or more traffic lights to be requested via a mobile radio link. The database or the data server on which the database is installed may be set up in a function as a control device particularly for performing the previously described method or portions thereof.

In line with one preferred embodiment of the apparatus, the data server is in contact with a receiver in a, in particular, global positioning or navigation system and is set up to ascertain the time base of the positioning or navigation system. This time base can be used as a reference time in order to prevent each set of traffic lights from having to know and precisely maintain the reference time itself.

For the purpose of adjustment and/or dynamic updating, for example in the event of changes to the change times, a set of traffic lights can perform the method according to aspects of the invention by transmitting the change times for the individual phases to the data server at prescribable intervals, when the time between change time and transmission is captured and also transmitted. Using this information, the data server can then transform the change time to the reference time and store it on the basis of this time base. On account of the short time between a change time for a phase changeover of the traffic lights and the transmission to the server, no significant inaccuracy arises in this case. However, it is possible to dispense with this procedure if the traffic lights know the reference time base themselves, for example because they are also equipped with a receiver for the positioning or navigation system or synchronize the reference time at regular intervals of time via a communication link. In some cases, traffic light controllers also have a program installed in them which firmly prescribes the change times. In that case, it is also possible, by way of example, to transmit the program and the starting time thereof to the database. On the basis of this, the database can calculate the change times for these traffic lights and store them in the database explicitly or as a computation rule. It is therefore sufficient, in principle, if the program and the starting time are transmitted only once, particularly when operation starts. For the purpose of synchronization however, it is appropriate to retransmit the starting time and possibly also the program at fixed intervals of time. A suitable period is 24 hours, for example, i.e. synchronization taking place once a day.

In a further development of the invention, the apparatus may also have a mobile transmission and reception device with an interface to a traffic light phase assistant. Said communication device is preferably mounted in a vehicle and may be a unit with the traffic light phase assistant, which actuates the communication device. Naturally, it is also possible for a control device which is separate from the traffic light phase assistant to be provided so that the apparatus can be operated independently of the traffic light phase assistant and merely provides it with the necessary information. In this latter variant, the apparatus proposed in accordance with the invention is suitable particularly for retrofitting existing traffic light phase assistants.

In a comprehensive refinement of the apparatus according to aspects of the invention, the transmission and reception device and/or the traffic light phase assistant are integrated in a driver assistance system which also has other functions and, in particular, is in the form of a computer, for example with a programmable microprocessor or comparable arithmetic and logic unit. In this case, the mobile portion of the apparatus according to aspects of the invention, which is distributed to the vehicle, may also be in the form of a computer program product which sets up the processor of the driver assistance system to perform the prescribed method and uses the components in the vehicle, particularly the transmission and reception device and the traffic light phase assistant, in a manner according to aspects of the invention.

Further advantages, features and opportunities for application of the present invention can be found in the description below of an exemplary embodiment and in the drawing. In this context, all the features described or shown in the FIGURES form the subject matter of the present invention on their own or in any combination, including independently of their synopsis in the claims or the back-references therein.

### BRIEF DESCRIPTION OF THE DRAWINGS

The invention is best understood from the following detailed description when read in connection with the accompanying drawing. Included in the drawings is the following FIGURE.

FIG. 1 schematically shows an embodiment of the inventive apparatus when the proposed method is performed.

### DETAILED DESCRIPTION OF THE PREFERRED EMBODIMENTS

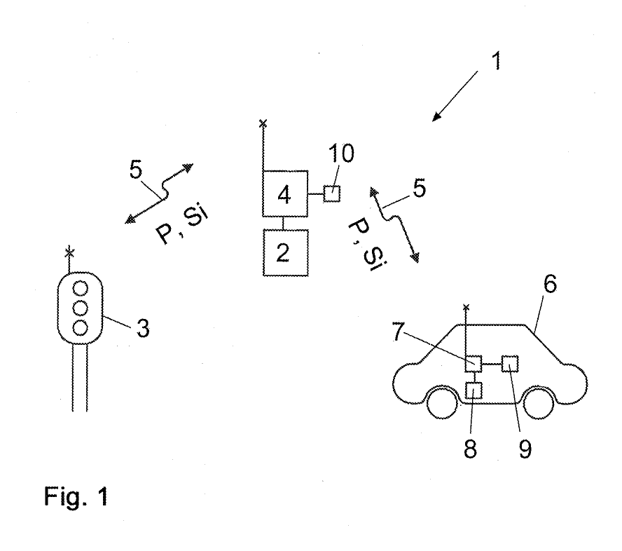

FIG. 1 shows an apparatus 1 for controlling the flow of traffic which has a data server 2 with a database which stores the position P and the change times Si of a set of traffic lights 3 for a multiplicity of traffic lights 3, wherein FIG. 1 shows only one data record (P, Si) for a set of traffic lights 3. The database 2 of the data server has a mobile radio communication device 4 connected to it which allows the position P and the change times Si of traffic lights 3 to be requested via a mobile radio link 5. By way of example, the mobile radio link 5 may be one of the mobile radio networks of the generations 2 G, 2.5 G, 2.75 G, 3 G or 4 G, which are typically available commercially and which allow the transmission of data at different transmission speeds.

Frequently, vehicles 6 are already equipped with appropriate mobile transmission and reception devices 7. Said transmission and reception device 7, which performs a multiplicity of data transmission operations from the vehicle 6 for other functional units too, has an interface to a traffic light phase assistant 8 which is implemented in the vehicle 6. The traffic light phase assistant 8 is set up to take information about the period of time before the traffic lights 3 change (change times Si) to another traffic light phase as a basis for providing the driver of the vehicle 6 with a speed recommendation for approaching the traffic lights 3 so that he reaches said traffic lights during the green phase as far as possible and does not need to stop at the traffic lights 3. To this end, under the control of the traffic light phase assistant 8, the data server or the database 2 is queried to determine what change times Si can be expected. In this case, the traffic lights 3 are identified by means of their position data P, which the car knows from a positioning or navigation system 9 which is likewise in contact with the mobile transmission and reception device.

The positioning or navigation system 9 also allows the current position of the vehicle 6 and the position P of the traffic lights 3 to be used by the traffic light phase assistant 8 to provide a very accurate speed recommendation for the approach to the traffic lights 3 which possibly involves even the current maximum speed or the nature of the road to be taken into account.

The common reference time used is the time base of a global positioning or navigation system, which also uses the positioning or navigation system 9 in the vehicle 6. By way of example, this may be the GPS system currently in widespread use, with other, for example future, systems such as the Galileo system also being suitable.

In order to adjust the change times Si of the traffic lights 3 to the common reference time, the apparatus 1 has a receiver 10—which is in contact with the mobile radio communication device 4 and the data server or the database 2—in the positioning or navigation system which is set up to ascertain the time base of the positioning or navigation system. This means that the change times Si transmitted by the traffic lights 3 or else by means of a mobile radio link 5 can be stored in the database 2 with the reference time which is valid throughout the system. In this way, synchronization problems of various clocks in different components throughout the system are avoided by using the common time base.

Since traffic lights 3 frequently also dynamically adapt their change times in response to a flow of traffic, it is proposed that the traffic lights 3 use the mobile radio link 5 to communicate these change times to the data server with the database 2 at regular intervals of time and/or when the change times Si are altered so that they can be dynamically kept up to date by means of a continuous update of the change times Si. In order to simplify the indexing in the system, dynamically changing change times can be identified in the database 2 and provided with an identifier (flag) which allows faster access to said change times for a continuous update. This can be done by specific indexing of said change times in the database 2, for example.

The present system is used to store the change times Si in connection with the position P of a set of traffic lights 3 for identification thereof in a preferably central database 2, from where they can also be retrieved via a mobile radio link 5 without a direct ad-hoc radio link between the traffic lights 3 and the vehicle 6. Mobile radio communication devices with a mobile transmission and reception device 7 are frequently installed in vehicles 6 for an Ecall, for example, so that it is possible to resort to existing communication technology. This is technically simpler than setting up ad-hoc network links. Hence, a traffic light phase assistant 8 has the necessary information available in a technically simple manner without the need for a direct radio communication link to be set up between the traffic lights 3 and the vehicle 6.

1.-13. (canceled)

14. A method for controlling a flow of traffic, in which information about a period of time before a set of traffic lights changes to another traffic light phase is used to provide a driver of a vehicle with a speed recommendation for approaching the traffic lights,
wherein a database is used to store a position (P) and change times (Si) of a set of traffic lights, and said position and change times can be retrieved by a vehicle via a mobile radio communication link, and
wherein the driver of the vehicle is provided with the speed recommendation using this information.

15. The method as claimed in claim 14, wherein a position of the vehicle relative to the traffic lights is also taken into account for the speed recommendation.

16. The method as claimed in claim 15, wherein the position of the vehicle and the position (P) of the traffic lights are taken into account in a digital roadmap.

17. The method as claimed in claim 15, wherein navigation data for the vehicle are taken into account for the speed recommendation.

18. The method as claimed in claim 14, wherein a speed of the vehicle is taken into account for the speed recommendation.

19. The method as claimed in claim 14, wherein a reference time used is a time base for a global positioning or navigation system.

20. The method as claimed in claim 14, wherein dynamic adaptation of traffic light phases involves the database being dynamically updated.

21. The method as claimed in claim 14, wherein the mobile radio communication link is effected using 2 G, 2.5 G, 2.75 G, 3 G and/or 4 G mobile radio networks.

22. The method as claimed in claim 14, wherein transmission of the change times (Si) for upcoming traffic lights involves change times for one or more subsequent set(s) of traffic lights that are also being transmitted.

23. An apparatus for controlling a flow of traffic for use with a traffic light phase assistant, which is set up to take information about a period of time before a set of traffic lights changes to another traffic light phase as a basis for providing a driver of a vehicle with a speed recommendation for approaching the traffic lights,
wherein a database is provided which stores a position (P) and a change times (Si) of a set of traffic lights, and
wherein a mobile radio communication device is connected to the database which allows the position (P) and the change times (Si) of a set of traffic lights to be requested via a mobile radio link.

24. The apparatus as claimed in claim 23, wherein the database is in contact with a receiver in a positioning or navigation system and is set up to ascertain a time base of the positioning or navigation system.

25. The apparatus as claimed in claim 23, wherein the apparatus has a mobile transmission and reception device with an interface to a traffic light phase assistant.

26. The apparatus as claimed in claim 23, wherein a transmission and reception device and/or the traffic light phase assistant is integrated in a driver assistance system.
